(19) United States
(12) Patent Application Publication
(10) Pub. No.: US 2008/0033590 A1
(43) Pub. Date: Feb. 7, 2008

(54) METHOD AND SYSTEM FOR MANAGING LOT TRANSACTIONS

(75) Inventors: Hsiang-Chen Huang, Hsinchu County (TW); Cheng-Yao Ni, Hsinchu County (TW); Tsung-Yang Chen, Hsinchu City (TW); I-Chieh Chung, Hsinchu City (TW); Wilson Hsu, Hsinchu City (TW); Chiech-Yi Kuo, Hsinchu City (TW)

Correspondence Address: THOMAS, KAYDEN, HORSTEMEYER & RISLEY LLP, 600 GALLERIA PARKWAY, 15TH FLOOR, ATLANTA, GA, 30339, US

(73) Assignee: TAIWAN SEMICONDUCTOR MANUFACTURING CO., LTD., Hsin-Chu (TW)

(21) Appl. No.: 11/462,057

(22) Filed: Aug. 3, 2006

(51) Int. Cl. G06F 19/00

(52) U.S. Cl. 700/115; 700/95

(57) ABSTRACT

A system for managing lot transactions among business units is provided. The system comprises an interface, storage device, and a processor. The interface provides an access to a lot transaction service for the business units. The storage device stores a preset business rule and manufacturing information corresponding to a lot, comprising lot ID, part ID, WIP quality, process flow, and validity of each of the business units. The processor, linking to the storage device and the interface, performs the lot transaction service for the business units, receives the lot sent and/or received notice, checks the sent/received notice according to a preset business rule, and updates the manufacturing information accordingly.

### BACKGROUND OF THE INVENTION

1. Field of the Invention

The invention relates to manufacturing management and in particular to methods and systems of managing lot transaction in a manufacturing environment.

2. Description of the Related Art

Manufacturing processes, such as semiconductor device manufacturing processes, commonly employ a series of processing steps. A semiconductor device goes through hundreds or thousands of steps before reaching its final form. The semiconductor device then undergoes a testing process, and is stored in a warehouse before shipping to another business unit (such as manufacturing unit (fab2), testing unit, joint venture, subcontractor, or customer). Additionally, for the transferring within manufacturing unit, the lot may not be stored in a central warehouse but through sending/receive gate of manufacturing unit. Transactions pertaining to the semiconductor device are recorded and managed by an accounting unit; this makes management problematic when a large number of semiconductor devices are transferred among several separate business units.

Hence, there is a need for a system that addresses the problems arising from the existing technology.

### BRIEF SUMMARY OF INVENTION

A system for managing lot transactions among business units is provided. The system comprises an interface, storage device, and a processor. The interface provides access to a lot transaction service for the business units. The storage device stores a preset business rule and manufacturing information corresponding to a lot, comprising lot ID, part ID, WIP quality, process flow, and validity of each of the business units. The processor, linking to the storage device and the interface, performs the lot transaction service for the business units, receives the lot sent and/or received notice, checks the sent/received notice according to a preset business rule, and updates the manufacturing information accordingly.

A method of managing lot transactions among business units is also provided. A preset business rule and manufacturing information corresponding to a lot are first provided. The manufacturing information comprises lot ID, part ID, WIP quality, process flow, and validity of each of the business units. Different manufacturing information may be required in different circumstances. For example, for accounting management needed, the manufacturing information also includes transaction code, which will be used to calculate the WIP cost increase/decrease of each business unit. For outsourcing management needed, the manufacturing information also includes subcontractor code. For warehouse management needed, the manufacturing information may include warehouse code. Access to a lot transaction service for the business units is then provided. The lot transaction service for the business units is performed. The lot sent and/or received notice is received. The sent/received notice is checked according to a preset business rule. The manufacturing information is updated accordingly.

### BRIEF DESCRIPTION OF DRAWINGS

The invention can be more fully understood by reading the subsequent detailed description and examples with references made to the accompanying drawings, wherein:

FIG. 1 illustrates an embodiment of a manufacturing system implementing lot transaction management;

FIG. 2 illustrates an embodiment of a system for managing lot transactions among business units;

FIG. 3 illustrates an embodiment of a system implementing lot transaction management; and

FIG. 4 is a flowchart of an embodiment of a method of managing lot transactions among business units.

### DETAILED DESCRIPTION OF INVENTION

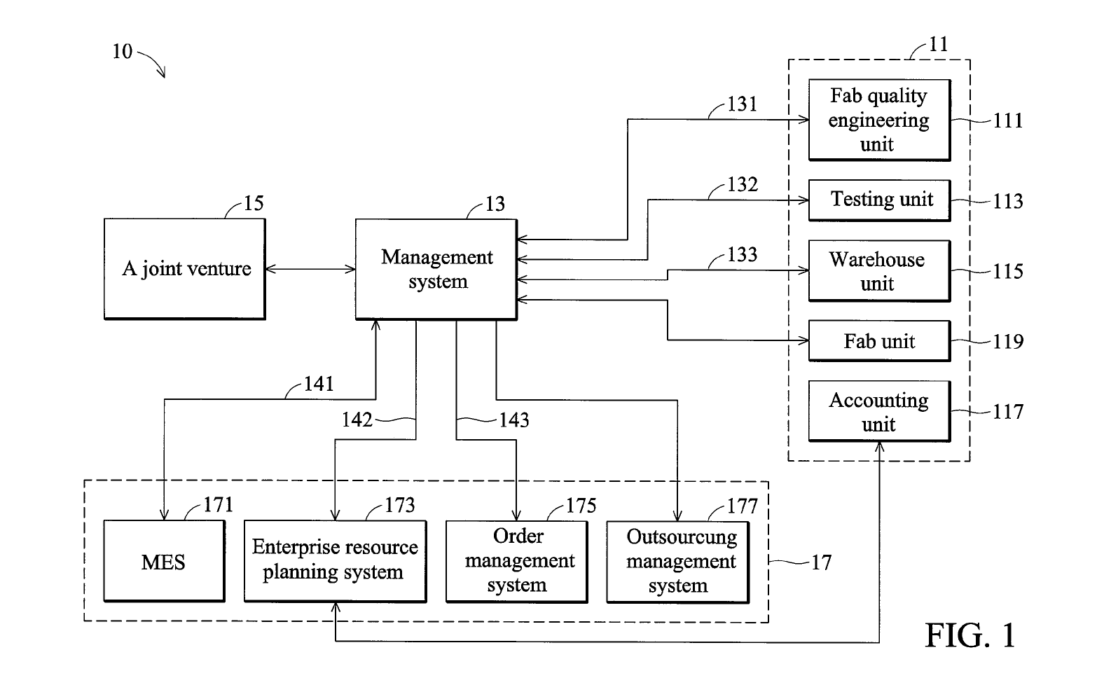

The invention will now be described with reference to FIGS. 1 through 4, which generally relate to systems and methods for managing lot transactions among business units.

In the following detailed description, reference is made to the accompanying drawings, which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the figure number, with the exception that the same reference number is used throughout to refer to an identical component, which appears in multiple figures.

FIG. 1 illustrates an embodiment of a manufacturing system using lot transaction management. Manufacturing system 10 comprises a management system 13, a logistic system 17, a joint venture 15, and business units within a manufacturer 11.

Manufacturer 11 comprises a plurality of business units. For example, manufacturer 11 can comprise fab quality engineering unit 111, a testing unit 113, a warehouse unit 115, an accounting unit 117, and a fab unit (manufacturing unit) 119. Fab quality engineering unit 111, a testing unit 113, and a warehouse unit 115 communicates with management system 13 through user interfaces 131, 132, and 133 respectively. It should be noted that the manufacturer 11 may also comprise a fab unit (not shown in FIG. 1), thus the invention is available for lot transfer between fab units.

Logistic system 17 processes manufacturing information pertaining to a plurality of lots. Logistic system 17 comprises a manufacturing executive system (MES) 171, an enterprise resource planning system 173, an order management system 175, and outsourcing (subcontractor) management system 177. Manufacturing executive system (MES) 171, an enterprise resource planning system 173, an order management system 175, and outsourcing management system 177 communicates with management system 13 with system interfaces 141, 142, 143, and 144, respectively. An accounting unit 117 of manufacturer 11 communicates with enterprise resource planning system 173 through user interface 134. The joint venture 15 communicates with management system 13 with a system interface 145.

All the lot transactions among the business units of joint venture 15 and business units within a manufacturer 11 can be accomplished by management system 13, and manufacturing information pertaining to the lot transactions may be updated accordingly.

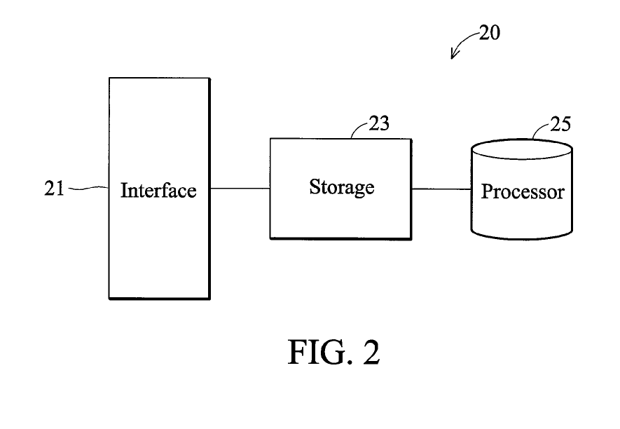

FIG. 2 illustrates an embodiment of a system for managing lot transactions among business units. The system for managing lot transactions among business units illustrated in FIG. 2 may be implemented by the management system 13 of FIG. 1. A system 20 comprises an interface 21, a storage device 25, and a processor 27.

The interface 21 provides access to a lot transaction service for a plurality of business units. The business units comprise business units within a manufacturer and a joint venture cooperating therewith. The business units within the manufacturer comprise a fab quality engineering unit, a testing unit, a warehouse unit, or an accounting unit.

The storage device 25 stores a preset business rule and manufacturing information corresponding to a lot, comprising lot ID, part ID, WIP quality, process flow, and validity of each of the business units.

The processor 23, linking to the storage device 25 and the interface 21, performs a lot transaction service for the business units, receives the lot sending and/or receiving notice, checks the sending/receiving notice according to a preset business rule, and updates the manufacturing information accordingly. Processor 23 further links to a manufacturing executive system (MES), a subcontractor management system, an order management system, and an enterprise resource planning system of the manufacturer. These systems linking to processor 23 may use heterogeneous computer systems, and specific adaptors may be utilized for bridging these computer systems to the processor 23.

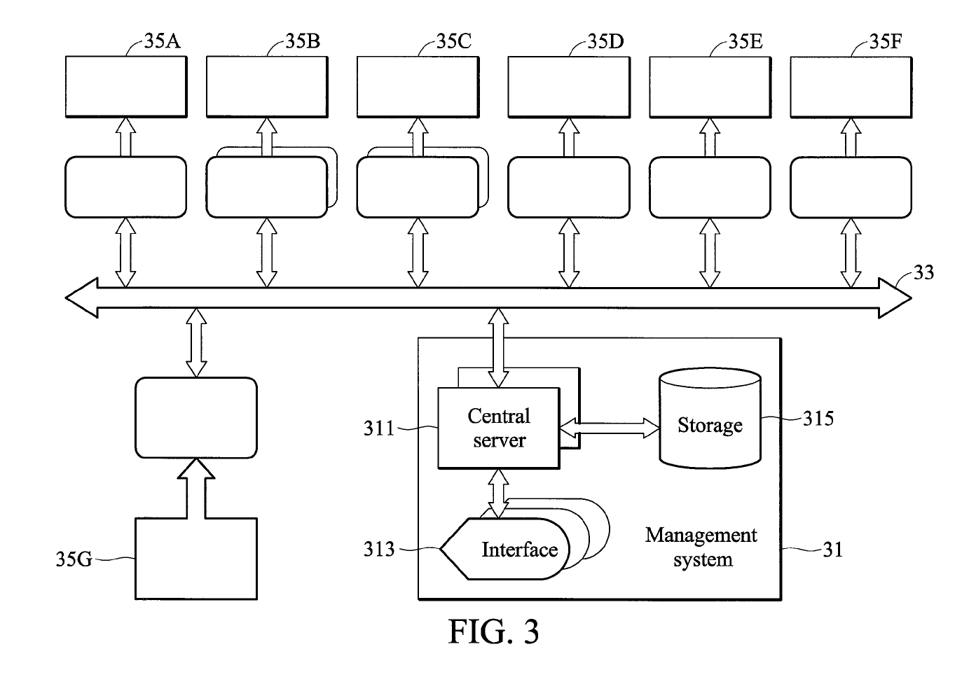

FIG. 3 illustrates an embodiment of a system implementing lot transaction management. A management system 31 comprises a central server 311, an interface 313, and a storage 315. The management system 31 provides access to a lot transaction service for a plurality of business units 35A˜35G through interface 313. Information pertaining to lot transactions is stored in storage 315. The management system 31 links to other systems via an EAI message bus 33. Management system 31 communicates with different types of computer systems. Each computer system type uses a specific adapter to communicate via EAI message bus 33. For example, separate SiVIEW systems use separate configure files for a SiVIEW adapter; separate PROMIS systems use separate configure files for a PROMIS adapter; separate POSIEDON systems use separate configure files for a POSIEDON adapter; separate ATS systems use separate configure files for a ATS adapter; separate SAP systems use separate configure files for a SAP adapter; separate TOM systems use separate configure files for a TOM adapter. Additionally, joint venture system uses a joint venture adapter.

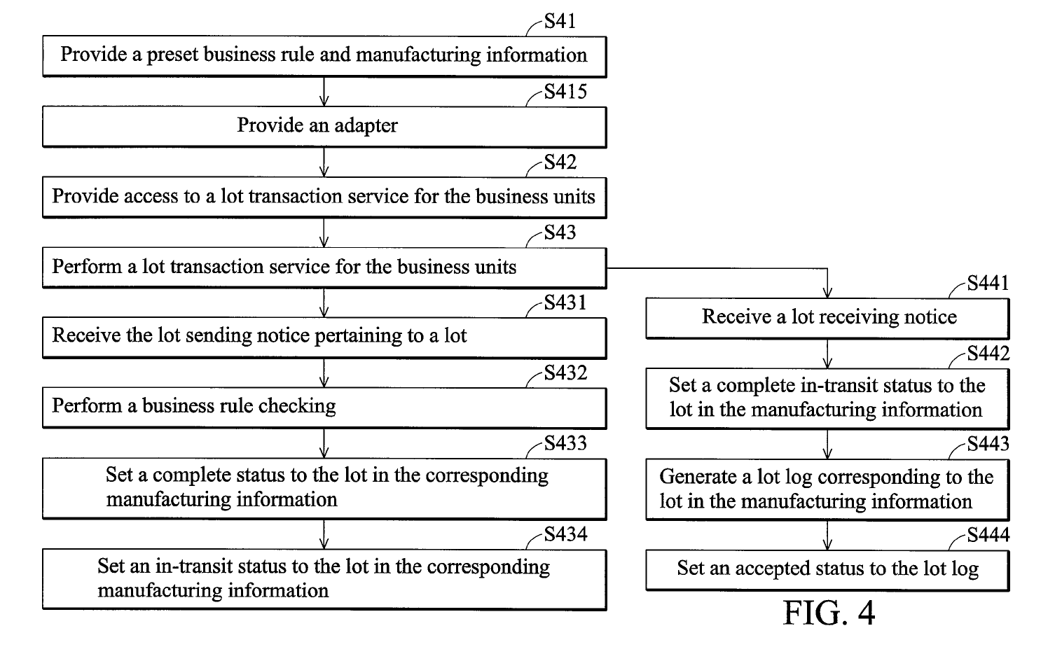

FIG. 4 is a flowchart of an embodiment of a method of managing lot transactions among business units.

In step S41, a preset business rule and manufacturing information are provided. The manufacturing information corresponds to a lot, comprising lot ID, part ID, WIP quality, process flow, and validity of each of the business units. In step S415, an adapter is provided for bridging the system and a type of computer system used by the business units, wherein the adapter comprises a first and second configure files for bridging first and second computer systems of the same type.

In step S42, access to a lot transaction service for the business units is provided. In step S43, a lot transaction service for the business units is performed. The lot transaction service pertains to sending/transferring/receiving a lot-in-transit

In step S431, the lot sent notice pertaining to a lot is received. In step S432, a business rule checking is performed on the lot sent notice based on the preset business rule. In step S433, a complete status is set to the lot in the corresponding manufacturing information, wherein the complete status is recorded in a manufacturing executive system. In step S434, an in-transit status is set to the lot in the corresponding manufacturing information, wherein the in-transit status is recorded in a center database.

In step S441, a lot receiving notice is received. In step S442, a complete in-transit status is set to the lot in the manufacturing information, wherein the complete in-transit status is recorded in a center database. In step S443, a lot log is generated corresponding to the lot in the manufacturing information, wherein the lot log is recorded in a manufacturing executive system. In step S444, an accepted status is set to the lot log.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for managing lot transactions among business units, comprising:
an interface providing access to a lot transaction service for the business units;
a storage device storing a preset business rule and manufacturing information corresponding to a lot, comprising lot ID, part ID, WIP quality, process flow, and validity of each of the business units;
a processor, linking to the storage device and the interface, performing the lot transaction service for the business units, receiving the lot sending and/or receiving notice, checking the sending/receiving notice according to the preset business rule, and updating the manufacturing information accordingly.

2. The system for managing lot transactions among business units of claim 1, wherein the business units comprise business units within a manufacturer and a joint venture cooperating therewith.

3. The system for managing lot transactions among business units of claim 2, wherein the business units within the manufacturer comprise a fab quality engineering unit, a testing unit, a warehouse unit, or an accounting unit.

4. The system for managing lot transactions among business units of claim 2, wherein the processor further links to a manufacturing executive system (MES), a subcontractor management system, an order management system, an enterprise resource planning system of the manufacturer.

5. The system for managing lot transactions among business units of claim 1, further comprising an adapter for bridging the system and a type of computer system used by the business units.

6. The system for managing lot transactions among business units of claim 5, wherein the adapter comprises a first and second configure files for bridging a first and a second computer systems of the same type.

7. The system for managing lot transactions among business units of claim 1, wherein the lot transaction service pertains to sending/transferring/receiving a lot-in-transit.

8. A method of managing lot transactions among business units, comprising:
providing a preset business rule and manufacturing information corresponding to a lot, comprising lot ID, part ID, WIP quality, process flow, and validity of each of the business units;
providing access to a lot transaction service for the business units;
performing the lot transaction service for the business units, receiving the lot sending and/or receiving notice, checking the sending/receiving notice according to the preset business rule, and updating the manufacturing information accordingly.

9. The method of managing lot transactions among business units of claim 8, further providing an adapter for bridging the system and a type of computer system used by the business units.

10. The method of managing lot transactions among business units of claim 9, further providing a first and second configure files for bridging a first and a second computer systems of the same type.

11. The method of managing lot transactions among business units of claim 8, further comprising:
receiving the lot sent notice pertaining to a lot;
performing a business rule checking on the lot sent notice based on the preset business rule;
setting a complete status for the lot in the corresponding manufacturing information; and
setting a in-transit status for the lot in the corresponding manufacturing information.

12. The method of managing lot transactions among business units of claim 11, wherein the complete status is recorded in a manufacturing executive system.

13. The method of managing lot transactions among business units of claim 11, wherein the in-transit status is recorded in a center database.

14. The method of managing lot transactions among business units of claim 8, further comprising:
receiving the lot receiving notice;
setting a complete in-transit status to the lot in the manufacturing information;
generating a lot log corresponding to the lot in the manufacturing information; and
setting an accepted status to the lot log.

15. The method of managing lot transactions among business units of claim 14, wherein the complete in-transit status is recorded in a center database.

16. The method of managing lot transactions among business units of claim 14, wherein the lot log is recorded in a manufacturing executive system.
